(19) United States
(12) Patent Application Publication
(10) Pub. No.: US 2006/0156549 A1
(43) Pub. Date: Jul. 20, 2006

(54) Etching blade of electric shaver

(76) Inventor: Tae-Jun O, Namyangju-shi (KR)

Correspondence Address: Hoffmann & Baron, 6900 Jericho Turnpike, Syosset, NY, 11791, US

(21) Appl. No.: 10/548,149

(22) PCT Filed: Mar. 4, 2004
(86) PCT No.: PCT/KR04/00455

§ 371 Date: Jan. 10, 2006

(30) Foreign Application Priority Data
Mar. 6, 2003 (KR) 20-2003-0006619

(51) Int. Cl. B26B 19/02

(52) U.S. Cl. 30/43.91

(57) ABSTRACT

Disclosed herein is an etched movable blade for use in an electric hair clipper. The electric hair clipper comprises a stationary blade in addition to the movable blade, and the movable blade is displaceably disposed on an upper surface of the stationary blade so as to perform hair cutting by making use of a plurality of etched blade teeth formed at tip ends of the movable and stationary blades. The movable blade comprises a plurality of etched recesses formed, respectively, between adjacent ones of the etched blade teeth, thereby achieving an increase in a surface area of etched portions compared to a conventional etched blade, and effectively preventing the accumulation of hair or residue between the stationary blade and the movable blade, resulting in enhancement in cutting efficiency of the electric hair clipper.

### TECHNICAL FIELD

The present invention relates to an etched blade of electric hair clippers, and more particularly to an etched movable blade for use in an electric hair clipper, which is displaceably disposed on the upper surface of a stationary blade of the electric hair clipper, and comprises a plurality of etched recesses, positioned, respectively, between adjacent ones of plural etched blade teeth separated by spaces, thereby preventing the accumulation of hair or residue between the stationary blade and the movable blade.

### BACKGROUND ART

Referring to FIG. 1 illustrating a conventional movable blade for use in an existing electric hair clipper and to FIG. 1b shown as a sectional view taken along the line A-A of FIG. 1a, the movable blade, designated as reference numeral 10, is formed, along a tip end of one surface thereof, with a plurality of recesses 25, by etching. These etched recesses 25, however, are insufficient to prevent the accumulation of hair or residue bet ween the movable blade and a stationary blade of the electric hair clipper, resulting in deterioration in cutting efficiency of the electric hair clipper.

### DISCLOSURE OF THE INVENTION

Therefore, the present invention has been made in view of the above problem, and it is an object of the present invention to provide an etched movable blade for use in an electric hair clipper which can improve sanitary conditions of the electric hair clipper and enhance cutting efficiency thereof.

In accordance with the present invention, the above and other objects can be ac complished by the provision of an etched movable blade for use in an electric hair clipper, the movable blade being displaceably disposed on an upper surface of a stationary blade of the hair clipper so that a plurality of etched blade teeth formed at a tip end of the movable blade reciprocate on upper surfaces of corresponding etched blade teeth formed at a tip end of the stationary blade for cutting hair, the movable blade comprising: a plurality of first etched recesses centrally formed at lower surfaces of the etched blade teeth in a one to one ratio; and a plurality of second etched recesses formed, respectively, between adjacent ones of the etched blade teeth.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a bottom view illustrating a movable blade for use in an electric hair clipper in accordance with the prior art;

FIG. 1b is a sectional view taken along the line A-A shown in FIG. 1a;

FIG. 2a is a bottom view illustrating a movable blade for use in an electric hair clipper in accordance with the present invention;

FIG. 2b is a sectional view taken along the line B-B shown in FIG. 2a;

FIG. 2c is a sectional view taken along the line C-C shown in FIG. 2a; and

FIG. 3 is a sectional view illustrating an assembled shape of the movable blade and a stationary blade of the electric hair clipper in accordance with the present invention.

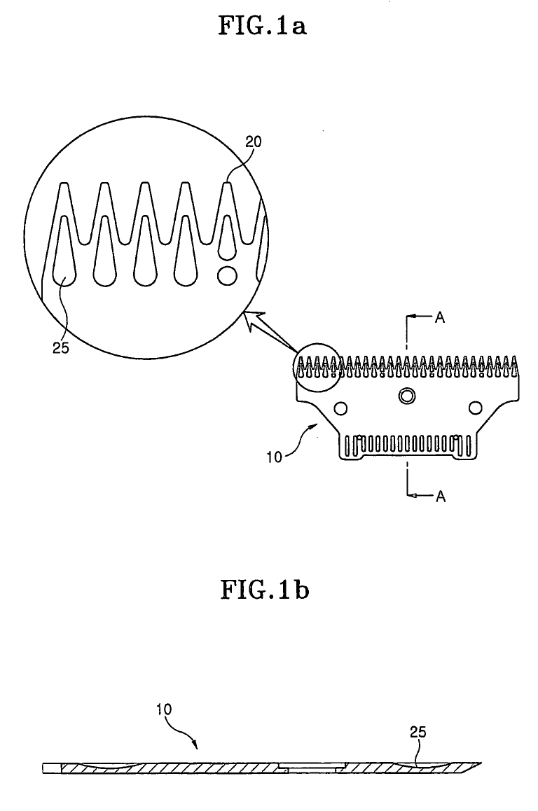

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

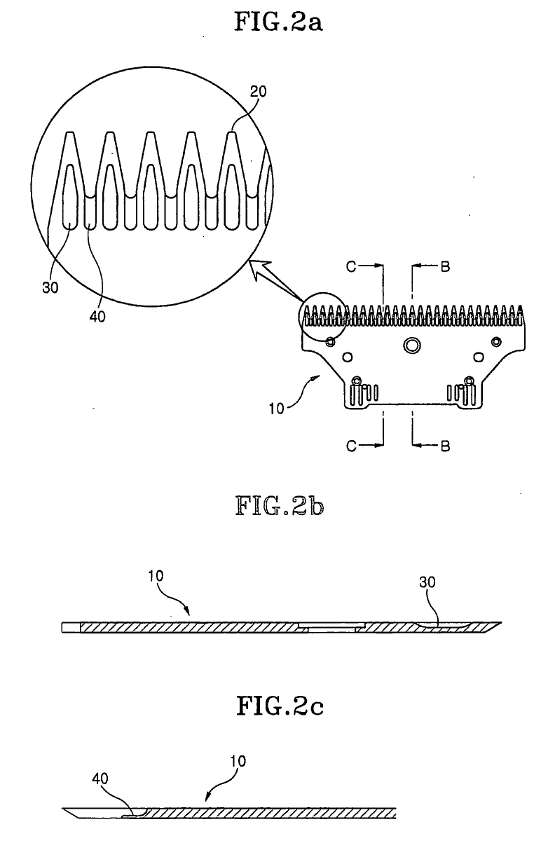

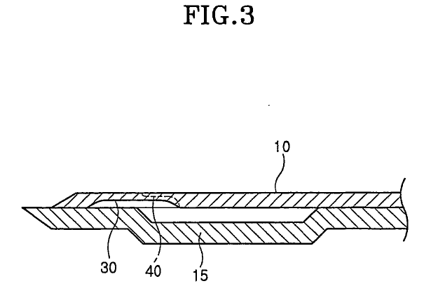

FIG. 2a is a bottom view illustrating a movable blade for use in an electric hair clipper in accordance with the present invention, and FIGS. 2b and 2c are sectional views taken along the line B-B and the line C-C shown in FIG. 2a, respectively. FIG. 3 is a sectional view illustrating an assembled shape of the movable blade and a stationary blade of the electric hair clipper in accordance with the present invention.

As shown in FIG. 2a, the movable blade 10 of the electric hair clipper comprises a plurality of etched blade teeth 20 arranged in a row along a tip end thereof, a plurality of first etched recesses 30 centrally formed at the etched blade teeth 20 in a one to one ratio, and a plurality of second etched recesses 40 positioned, respectively, between adjacent ones of the etched blade teeth 20, that is, between adjacent ones of the first etched recesses 30. Through the use of the second etched recesses 40 as well as the first etched recesses 30, the movable blade 10 of the present invention essentially eliminates a conventional problem of accumulation of hair or residue between the movable blade 10 and a stationary blade (designated as reference numeral 15 in FIG. 3).

As can be seen from FIGS. 2b and 2c, each of the first etched recesses 30 of the movable blade 10 defines a surface area wider than that of a recess conventionally formed at an existing electric hair clipper, thereby increasing its ability to prevent the accumulation of hair or residue between the movable blade 10 and the stationary blade 15.

Referring to FIG. 3, in assembly, the movable blade 10 is displaceably disposed on an upper surface of the stationary blade 15 so that the first etched recesses 30 and second etched recesses 40 formed at a lower surface of the movable blade 10 face the upper surface of the stationary blade 15.

As stated above, by virtue of the fact that the first etched recesses 30 define a wider surface area than the conventional recesses, and the second etched recesses 40 are additionally formed between the adjacent etched blade teeth 20, respectively, the present invention effectively prevents the accumulation of hair or residue between the movable blade 10 and stationary blade 15 of the electric hair clipper during hair cutting operation, resulting in an enhancement in cutting efficiency thereof.

### INDUSTRIAL APPLICABILITY

As apparent from the above description, the present invention provides an etched movable blade for use in an electric hair clipper, which comprises a plurality of etched recesses, positioned, respectively, between adjacent ones of etched blade teeth formed at a tip end of the movable blade, in addition to other etched recesses centrally formed at the etched blade teeth in a one to one ratio, thereby effectively preventing the accumulation of hair or residue between the movable blade and a stationary blade of the electric hair clipper. As a result, it is possible to achieve considerable improvement in sanitary conditions and cutting efficiency of the electric hair clipper.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An etched movable blade for use in an electric hair clipper, the movable blade being displaceably disposed on an upper surface of a stationary blade of the hair clipper so that a plurality of etched blade teeth formed at a tip end of the movable blade reciprocate on upper surfaces of corresponding etched blade teeth formed at a tip end of the stationary blade for cutting hair, the movable blade comprising:
a plurality of first etched recesses centrally formed at lower surfaces of the etched blade teeth in a one to one ratio; and
a plurality of second etched recesses formed, respectively, between adjacent ones of the etched blade teeth.
